(19) United States
(12) Patent Application Publication
(10) Pub. No.: US 2025/0055617 A1
(43) Pub. Date: Feb. 13, 2025

(54) RETRANSMISSION METHOD AND APPARATUS, AND STORAGE MEDIUM

(71) Applicant: Beijing Xiaomi Mobile Software Co., Ltd., Beijing (CN)

(72) Inventors: Zhenyu ZHANG, Beijing (CN); Xueyuan GAO, Beijing (CN)

(73) Assignee: Beijing Xiaomi Mobile Software Co., Ltd., Beijing (CN)

(21) Appl. No.: 18/721,393

(22) PCT Filed: Dec. 23, 2021
(86) PCT No.: PCT/CN2021/140667

§ 371 Date: Jun. 18, 2024

(51) Int. Cl. H04L 5/00; H04L 1/1867

(52) U.S. Cl. CPC H04L 5/0035; H04L 1/1887

(57) ABSTRACT

The present disclosure provides a retransmission method and apparatus, and a storage medium. The retransmission method includes: determining that channel collision occurs between at least two uplink channels for duplication transmission, wherein the at least two uplink channels are respectively transmitted by the at least two transceiving points (TRPs); determining, in the at least two uplink channels, a first uplink channel that discards some time units; determining the number of duplication transmissions corresponding to the time units preserved in the first uplink channel; determining, on the basis of the number of retransmissions, a target TRP among the at least two TRPs; and transmitting, via the target TRP, information of the time units preserved in the first uplink channel.

### CROSS-REFERENCE TO RELATED APPLICATIONS

The present application is a U.S. National Stage of International Application No. PCT/CN2021/140667, filed on Dec. 23, 2021, the contents of which are incorporated herein by reference in its entirety for all purposes.

### TECHNICAL FIELD

The present disclosure relates to the field of communications, and more particularly, to a retransmission method and apparatus, and a storage medium.

### BACKGROUND

At present, Release-17 (Rel-17) Multiple-Transmission Reception Point (M-TRP) uplink channel retransmission may follow channel collision rules in Rel-16. If information of retransmission of Physical Uplink Control Channel (PUCCH) carrying Uplink Control Information (UCI) with a low priority or information of retransmission of Physical Uplink Shared Channel (PUSCH) carrying the UCI with the low priority is discarded due to channel collision, there will occur two cases where the reserved channel information will be transmitted by either the M-TRP or Single-Transmission Reception Point (S-TRP).

### SUMMARY

Embodiments of the present disclosure provide a retransmission method and apparatus, and a storage medium.

According to a first aspect of embodiments of the present disclosure, there is provided a retransmission method, which is applied to a terminal, and the method includes:
determining that at least two uplink channels for retransmission are subject to channel collision, wherein the at least two uplink channels are respectively transmitted by at least two Transmission Reception Points (TRPs);
determining, among the at least two uplink channels, a first uplink channel in which part of time units is discarded;
determining a number of retransmissions corresponding to a time unit reserved in the first uplink channel;
determining, among the at least two TRPs, a target TRP based on the number of retransmissions; and
transmitting, by the target TRP, information of the time unit reserved in the first uplink channel.

According to a second aspect of embodiments of the present disclosure, there is provided a computer-readable storage medium having a computer program stored thereon, wherein the computer program is configured to implement any retransmission method as described above.

According to a third aspect of embodiments of the present disclosure, there is provided a communication device, including:
a processor; and
a memory configured to store executable instructions of the processor;
wherein the processor is configured to execute the executable instructions to implement any retransmission method as described above.

It should be noted that the above general description and the following detailed description are merely exemplary and explanatory and should not be construed as limiting of the disclosure.

### BRIEF DESCRIPTION OF THE DRAWINGS

The accompanying drawings, which are incorporated in and constitute a part of this specification, illustrate embodiments consistent with the present disclosure and, together with the description, serve to explain principles of the present disclosure.

FIG. 1A to FIG. 1C show schematic diagrams of channel collision processing according to an embodiment of the present disclosure.

FIG. 2 shows a schematic flowchart of a retransmission method according to an embodiment of the present disclosure.

FIG. 3 shows a schematic flowchart of another retransmission method according to an embodiment of the present disclosure.

FIG. 4 shows a schematic flowchart of another retransmission method according to an embodiment of the present disclosure.

FIG. 5 shows a schematic flowchart of another retransmission method according to an embodiment of the present disclosure.

FIG. 6 shows a schematic flowchart of another retransmission method according to an embodiment of the present disclosure.

FIG. 7 shows a schematic flowchart of another retransmission method according to an embodiment of the present disclosure.

FIG. 8 shows a schematic flowchart of another retransmission method according to an embodiment of the present disclosure.

FIGS. 9A to 9C shows schematic diagrams of a retransmission processing manner according to an embodiment of the present disclosure.

FIGS. 10A to 10D shows schematic diagrams of a retransmission processing manner according to an embodiment of the present disclosure.

FIG. 11 shows a schematic diagram of a retransmission processing manner according to an embodiment of the present disclosure.

FIG. 12 shows a block diagram of a retransmission apparatus according to an embodiment of the present disclosure.

FIG. 13 shows a schematic structural diagram of a communication device according to an embodiment of the present disclosure.

### DETAILED DESCRIPTION

Reference will now be made in detail to embodiments, examples of which are illustrated in the accompanying drawings. The following description refers to the accompanying drawings in which the same numbers in different drawings represent the same or similar elements unless otherwise represented. The implementations set forth in the following description of the embodiments do not represent all implementations consistent with the present disclosure. Instead, they are merely examples of apparatuses and methods consistent with some aspects of the present disclosure as recited in the appended claims.

The terms used in the present disclosure are merely for the purpose of describing particular embodiments and are not intended to limit the present disclosure. As used in the present disclosure and the appended claims, the singular forms “a”, “said” and “the” are intended to include the plural forms as well, unless the context clearly indicates otherwise. It should also be understood that the term “and/or” as used herein refers to and includes any or all possible combinations of at least one the associated listed items.

It should be understood that, although the terms first, second, third, etc. may be used in the present disclosure to describe various information, such information should not be limited to these terms. These terms are only used to distinguish the same type of information from each other. For example, without departing from the scope of the present disclosure, the first indication information may also be referred to as the second information, and similarly, the second information may also be referred to as the first information. Depending on the context, the word “if” as used herein can be interpreted as “upon” or “when” or “in response to determination”.

As described above, at present, Release-17 (Rel-17) Multiple-Transmission Reception Point (M-TRP) uplink channel retransmission may follow channel collision rules in Rel-16. If information of retransmission of Physical Uplink Control Channel (PUCCH) carrying Uplink Control Information (UCI) with a low priority or information of retransmission of Physical Uplink Shared Channel (PUSCH) carrying the UCI with the low priority is discarded due to channel collision, there will occur two cases where the reserved channel information will be transmitted by either the M-TRP or Single-Transmission Reception Point (S-TRP).

If the transmission is based on the S-TRP, a space diversity gain of an M-TRP system cannot be obtained. In particular, when the TRP experiences deep fading or obstruction, reliability of the M-TRP system will be reduced. In addition, when the channel collision occurs between the sub-slot-based retransmission of the PUCCH carrying the UCI with the low priority and the slot-based retransmission of the PUCCH carrying the UCI with the high priority, it will cause a transmission delay of the UCI with the low priority.

A terminal at a cell edge has a lower Quality of Service (QoS) since it is relatively far from a base station and has a relatively poor channel status condition. In order to improve the reliability and spectrum efficiency of the terminal at the cell edge, flexible M-TRP deployment may be used to effectively alleviate inter-cell interference, so as to meet requirements for a large coverage and a high throughput in in 5th Generation Mobile Communication Technology (5G).

During a standardization process of Rel-16, it is specified discarding rules for channel collision during an S-TRP transmission in a Multiple-Input Multiple-Output (MIMO) system. When two channels occupy one or more identical slot resources, it is considered that the channel collision occurs. For uplink channel transmission and uplink channel retransmission, that is, PUCCH transmission, PUSCH transmission, PUCCH retransmission and PUSCH retransmission, a priority index may be configured, and a priority index value may be 0 or 1.

For example, a priority index for an unscheduled (or scheduling-free) PUSCH may be configured through a parameter phy-PriorityIndex (which refers to a physical layer priority index), and a priority index for a PUSCH carrying Semi-Persistent Channel State Information (SP-CSI) may be configured through a priority indication field in a Downlink Control Information (DCI) format. If the base station does not provide the priority index value for the uplink channel, the priority index value is set to 0 by default.

The channel collision rules in Rel-16 may include the following situations:

Situation 1: two uplink channels subject to the channel collision have different priority indexes.

Situation 1-1: when high-priority PUCCH transmission (or high-priority PUCCH retransmission) and low-priority PUCCH transmission (or low-priority PUSCH transmission, or low-priority PUCCH retransmission, or low-priority PUSCH retransmission) are overlapped in one or more slots, information of a low-priority uplink channel is discarded in the overlapping slot.

Situation 1-2: when high-priority PUSCH transmission (or high-priority PUSCH retransmission) and the low-priority PUCCH transmission (or the low-priority PUCCH retransmission) are overlapped in on one or more slots, the information of the low-priority uplink channel is discarded in the overlapping slot.

Situation 2: two channels subject to the channel collision have the same priority index.

Situation 2-1: when the PUCCH retransmission and the PUCCH transmission (or the PUCCH retransmission) are overlapped in one or more slots, the terminal will not transmit information of two PUCCHs with the same starting slot and carrying UCI with the same priority.

When the terminal transmits two PUCCHs carrying the UCI with the same priority, information of a PUCCH with a later starting slot is discarded in the overlapping slot; and when the terminal transmits two PUCCHs carrying UCI with different priorities, information of a PUCCH carrying UCI with a lower priority is discarded in the overlapping slot.

The UCI with the priority order from high to low is respectively: Hybrid Automatic Repeat Request-Acknowledgement (HARQ-ACK), Scheduling Request (SR), high-priority Channel State Information (CSI), and low-priority CSI.

Situation 2-2: when the PUCCH retransmission and the PUSCH retransmission are overlapped in one or more slots, and a type of the PUSCH retransmission is type A, information of the PUSCH retransmission is discarded in the overlapping slot.

Situation 2-3: when the PUCCH retransmission and the PUSCH retransmission are overlapped in one or more slots, and the type of the PUSCH retransmission is type B, information of the actual PUSCH retransmission is discarded in the overlapping slot.

When two channels that are collided with each other have different priority indices, M-TRP PUCCH transmission in Rel-17 may follow the channel collision rules in Rel-16. For a scenario where two channels subject to the channel collision with each other have the same priority index, according to the channel collision rules in Rel-16, when the channel collision occurs during the M-TRP PUCCH retransmission, specific situations are as follows.

Situation 1: when the PUCCH retransmission and the PUCCH transmission (or the PUCCH retransmission) are overlapped in one or more slots, the terminal will not transmit information of two PUCCHs with the same starting slot and carrying UCI with the same priority.

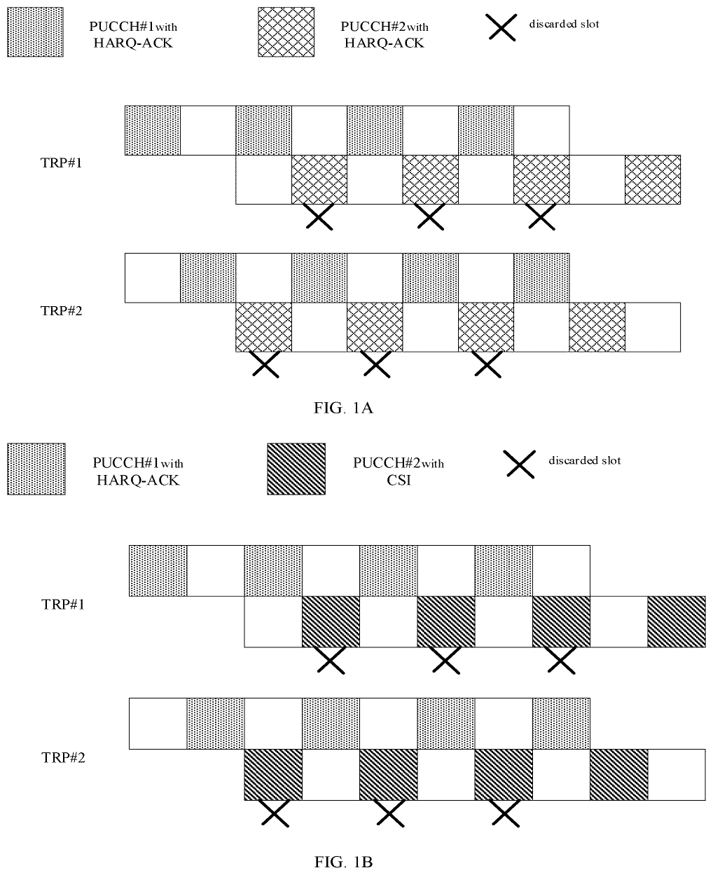

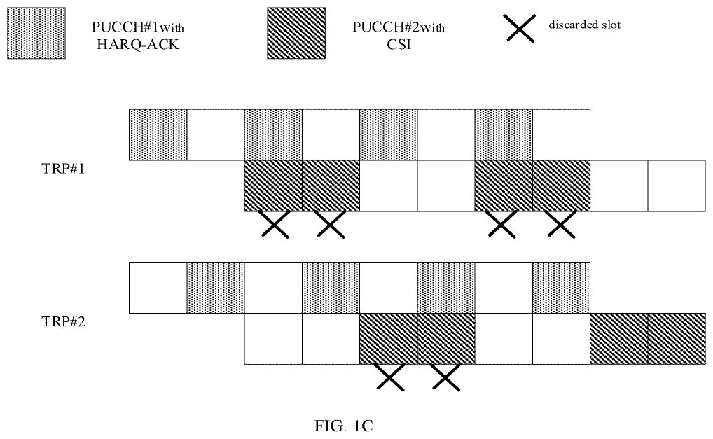

When the terminal transmits two PUCCHs carrying the UCI with the same priority, information of a PUCCH with a later starting slot is discarded in the overlapping slot. For example, in FIG. 1A, two PUCCHs carry UCI with the same priority, which is HARQ-ACK, and PUCCH #2 has a later starting slot, in this case, information of PUCCH #2 is discarded in the overlapping slot.

When the terminal transmits two PUCCHs carrying UCI with different priorities, information of a PUCCH carrying UCI with a lower priority is discarded in the overlapping slot. For example, in FIG. 1B, two PUCCHs carry UCI with different priorities, where the UCI carried by PUCCH #1 is HARQ-ACK, and the UCI carried by PUCCH #2 is CSI. A priority of HARQ-ACK is higher than that of CSI, and accordingly, information of PUCCH #2 carrying the low-priority UCI is discarded in the overlapping slot.

As another example shown in FIG. 1C, information of PUCCH #2 carrying the low-priority UCI is also discarded in the overlapping slot.

Situation 2: when the PUCCH retransmission and the PUSCH retransmission are overlapped in one or more slots, and a type of the PUSCH retransmission is type A, information of the PUSCH retransmission is discarded in the overlapping slot.

Situation 3: when the PUCCH retransmission and the PUSCH retransmission are overlapped in one or more slots, and the type of the PUSCH retransmission is type B, information of the actual PUSCH retransmission is discarded in the overlapping slot.

The above-mentioned PUCCH retransmissions are all slot-based retransmissions. In addition, sub-slot-based PUCCH retransmission is introduced in Rel-17. Assuming that there occurs the channel collision between the sub-slot-based PUCCH retransmission and the slot-based PUCCH retransmission in a certain slot, and a starting symbol of the slot-based PUCCH is earlier and the carried UCI has a higher priority, information of the sub-slot-based PUCCH retransmission (which may be repeated 2 times or more) in the slot is discarded according to the channel collision rules in Rel-16.

At present, the uplink channel in which part of slots is discarded due to the channel collision is only transmitted on the S-TRP, and the space diversity gain of the M-TRP system cannot be obtained. In addition, when the channel collision occurs between the sub-slot-based retransmission of the PUCCH carrying the UCI with the low priority and the retransmission of the PUCCH carrying the UCI with the high priority, it will cause the transmission delay of the UCI with the low priority.

The present disclosure provides the following retransmission method, which can improve the transmission reliability of the M-TRP system.

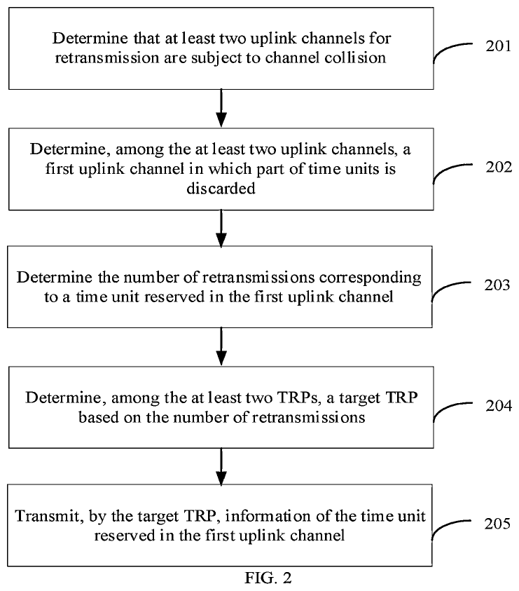

Embodiments of the present disclosure provide a retransmission method. FIG. 2 shows a flowchart of a retransmission method according to an embodiment, which may be used in a terminal. As shown in FIG. 2, the method may include steps 201 to 205.

In the step 201, it is determined that at least two uplink channels for retransmission are subject to channel collision.

In embodiments of the present disclosure, the uplink channel used for retransmission may refer to a PUCCH retransmission channel or a PUSCH retransmission channel, and the at least two uplink channels may be transmitted by at least two Transmission Reception Points (TRPs), respectively. When the at least two uplink channels used for retransmission overlap in one or more time units, it is determined that the channel collision occurs in the at least two uplink channels for retransmission. The time unit may be a slot or a sub-slot.

In the step 202, a first uplink channel in which part of time units is discarded is determined among the at least two uplink channels.

In embodiments of the present disclosure, the at least two uplink channels may carry UCI with different priorities.

In an implementation, the terminal may use, among the at least two channels, an uplink channel carrying UCI with the lowest priority as the first uplink channel.

In the step 203, the number of retransmissions corresponding to a time unit reserved in the first uplink channel is determined.

In the step 204, a target TRP among the at least two TRPs is determined based on the number of retransmissions.

In embodiments of the present disclosure, one or more of the at least two TRPs may be used as the target TRP based on the number of retransmissions.

In the step 205, information of the time unit reserved in the first uplink channel is transmitted by the target TRP.

According to the related arts, the TRP used to transmit the first uplink channel is always used to transmit the information of the time unit reserved in the first uplink channel. However, in the present disclosure, the terminal may re-determine the target TRP from the at least two TRPs, and then the target TRP transmits the information of the time unit reserved in the first uplink channel in which part of the time units has been discarded, thereby improving the transmission reliability of the M-TRP system.

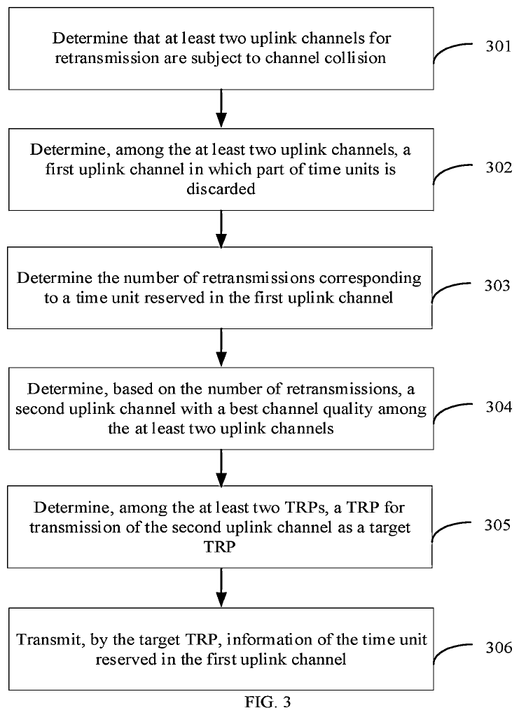

In some embodiments, referring to FIG. 3, which shows a flowchart of a retransmission method according to an embodiment, the method may be used in the terminal, and may include steps 301 to 306.

In the step 301, it is determined that at least two uplink channels for retransmission are subject to channel collision.

In embodiments of the present disclosure, the uplink channel used for retransmission may refer to a PUCCH retransmission channel or a PUSCH retransmission channel, and the at least two uplink channels may be transmitted by at least two Transmission Reception Points (TRPs), respectively. When the at least two uplink channels used for retransmission overlap in one or more time units, it is determined that the channel collision occurs in the at least two uplink channels for retransmission. The time unit may be a slot or a sub-slot.

In the step 302, a first uplink channel in which part of time units is discarded is determined among the at least two uplink channels.

In embodiments of the present disclosure, the at least two uplink channels may carry UCI with different priorities.

In an implementation, the terminal may use, among the at least two channels, an uplink channel carrying UCI with the lowest priority as the first uplink channel.

In the step 303, the number of retransmissions corresponding to a time unit reserved in the first uplink channel is determined.

In the step 304, a second uplink channel with a best channel quality among the at least two uplink channels is determined based on the number of retransmissions.

In embodiments of the present disclosure, an uplink channel with the best channel quality among the at least two uplink channels may be determined as the second uplink channel. The second uplink channel and the first uplink channel mentioned above may be the same channel or different channels.

In an implementation, the terminal may determine the uplink channel with the best channel quality among the at least two uplink channels based on a signal strength of a channel reference signal, and then use this channel as the second uplink channel.

In the step 305, a TRP for transmission of the second uplink channel among the at least two TRPs is determined as the target TRP.

In an implementation, the number of retransmissions is 1, and the number of target TRPs is also 1. In another implementation, the number of retransmissions is greater than 1, and the number of target TRPs is 1. That is, regardless of the number of retransmissions, the TRP used to transmit the second uplink channel with the best channel quality can be used as the target TRP.

In the step 306, information of the time unit reserved in the first uplink channel is transmitted by the target TRP.

According to the related arts, the TRP used to transmit the first uplink channel is always used to transmit the information of the time unit reserved in the first uplink channel. However, in the present disclosure, the terminal may re-determine, among the at least two TRPs, the TRP corresponding to the uplink channel with the best channel quality, and use this TRP as the target TRP, and then the target TRP transmits the information of the time unit reserved in the first uplink channel in which part of the time units has been discarded, thereby improving the transmission reliability of the M-TRP system.

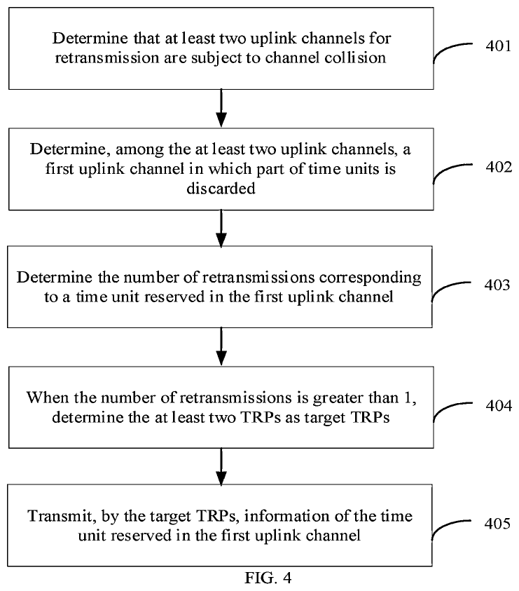

In some embodiments, referring to FIG. 4, which shows a flowchart of a retransmission method according to an embodiment, the method may be used in the terminal, and may include steps 401 to 405.

In the step 401, it is determined that at least two uplink channels for retransmission are subject to channel collision.

In embodiments of the present disclosure, the uplink channel used for retransmission may refer to a PUCCH retransmission channel or a PUSCH retransmission channel, and the at least two uplink channels may be transmitted by at least two Transmission Reception Points (TRPs), respectively. When the at least two uplink channels used for retransmission overlap in one or more time units, it is determined that the channel collision occurs in the at least two uplink channels for retransmission. The time unit may be a slot or a sub-slot.

In the step 402, a first uplink channel in which part of time units is discarded is determined among the at least two uplink channels.

In embodiments of the present disclosure, the at least two uplink channels may carry UCI with different priorities.

In an implementation, the terminal may use, among the at least two channels, an uplink channel carrying UCI with the lowest priority as the first uplink channel.

In the step 403, the number of retransmissions corresponding to a time unit reserved in the first uplink channel is determined.

In embodiments of the present disclosure, the number of retransmissions may be greater than 1.

In the step 404, when the number of retransmissions is greater than 1, the at least two TRPs are determined as target TRPs.

In embodiments of the present disclosure, the at least two TRPs may be used as the target TRP. That is, when the number of retransmissions is greater than 1, the number of target TRPs is the same as the number of the at least two uplink channels.

In the step 405, information of the time unit reserved in the first uplink channel is transmitted by the target TRP.

In the above embodiments, the information of the time unit reserved in the first uplink channel can be transmitted by the at least two TRPs to obtain the space diversity gain of the M-TRP system, thereby improving the reliability of the M-TRP system.

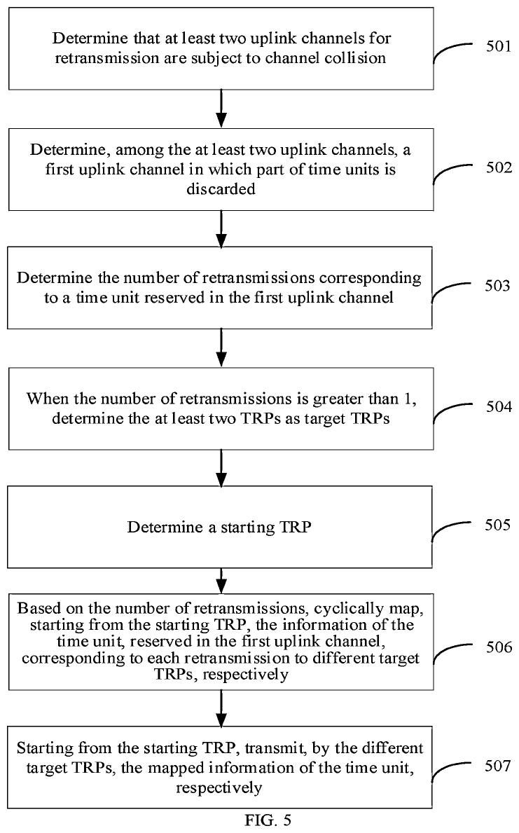

In some embodiments, referring to FIG. 5, FIG. 5 shows a flowchart of a retransmission method according to an embodiment, the method may be used in the terminal, and may include steps 501 to 507.

In the step 501, it is determined that at least two uplink channels for retransmission are subject to channel collision.

In embodiments of the present disclosure, the uplink channel used for retransmission may refer to a PUCCH retransmission channel or a PUSCH retransmission channel, and the at least two uplink channels may be transmitted by at least two Transmission Reception Points (TRPs), respectively. When the at least two uplink channels used for retransmission overlap in one or more time units, it is determined that the channel collision occurs in the at least two uplink channels for retransmission. The time unit may be a slot or a sub-slot.

In the step 502, a first uplink channel in which part of time units is discarded is determined among the at least two uplink channels.

In embodiments of the present disclosure, the at least two uplink channels may carry UCI with different priorities.

In an implementation, the terminal may use, among the at least two channels, an uplink channel carrying UCI with the lowest priority as the first uplink channel.

In the step 503, the number of retransmissions corresponding to a time unit reserved in the first uplink channel is determined.

In embodiments of the present disclosure, the number of retransmissions may be greater than 1.

In the step 504, when the number of retransmissions is greater than 1, the at least two TRPs are determined as target TRPs.

In embodiments of the present disclosure, the at least two TRPs may be used as the target TRP. That is, when the number of retransmissions is greater than 1, the number of target TRPs is the same as the number of the at least two uplink channels.

In the step 505, a starting TRP is determined.

In embodiments of the present disclosure, the starting TRP is a TRP among the target TRPs that starts transmitting the information of the time unit reserved in the first uplink channel the earliest.

In an implementation, any one of the at least two TRPs may be determined as the starting TRP.

In another implementation, a TRP used to transmit the first uplink channel may be determined as the starting TRP.

In the step 506, starting from the starting TRP, the information of the time unit, reserved in the first uplink channel, corresponding to each retransmission is cyclically mapped, based on the number of retransmissions, to different target TRPs, respectively.

In embodiments of the present disclosure, a cyclic mapping manner may be used to map the information of the time unit, reserved in the first uplink channel, corresponding to each retransmission to the different target TRPs, respectively.

In the step 507, starting from the starting TRP, the mapped information of the time unit is transmitted by the different target TRPs, respectively.

In the above embodiments, the information of the time unit reserved in the first uplink channel can be mapped to the different target TRPs through the cyclic mapping manner, and then transmitted by the target TRPs, so as to obtain the space diversity gain of the M-TRP system, thereby improving the reliability of the M-TRP system.

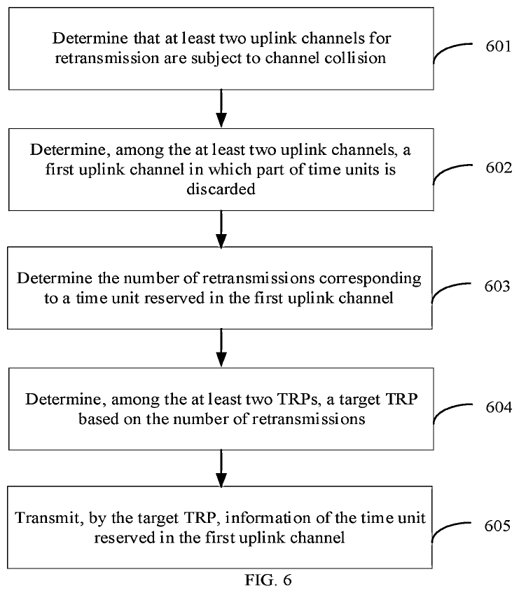

In some embodiments, referring to FIG. 6, FIG. 6 shows a flowchart of a retransmission method according to an embodiment, the method may be used in the terminal, and may include steps 601 to 605.

In the step 601, it is determined that at least two uplink channels for retransmission are subject to channel collision.

In embodiments of the present disclosure, the uplink channel used for retransmission may refer to a PUCCH retransmission channel or a PUSCH retransmission channel, and the at least two uplink channels may be transmitted by at least two Transmission Reception Points (TRPs), respectively. When the at least two uplink channels used for retransmission overlap in one or more time units, it is determined that the channel collision occurs in the at least two uplink channels for retransmission. The time unit may be a slot or a sub-slot.

In the step 602, a first uplink channel in which part of time units is discarded is determined among the at least two uplink channels.

In embodiments of the present disclosure, the at least two uplink channels may carry UCI with different priorities.

In an implementation, the terminal may use, among the at least two channels, an uplink channel carrying UCI with the lowest priority as the first uplink channel.

In the step 603, the number of retransmissions corresponding to a time unit reserved in the first uplink channel is determined.

The first uplink channel is a PUSCH, and the retransmission type is a first type. Specifically, the first type may be type B, i.e., mini-slot repetition, which is a type that allows retransmission across slots.

In an implementation, the nominal number of retransmissions corresponding to the time unit reserved in the first uplink channel is directly determined without considering whether there is the retransmission across slots.

In another implementation, the actual number of retransmissions corresponding to the time unit reserved in the first uplink channel is determined. For example, the nominal number of retransmissions corresponding to the time unit reserved in the PUSCH is 2, and one nominal retransmission is divided into two actual retransmissions by a slot boundary, and the actual number of retransmissions corresponding to the time unit included in the PUSCH is 3.

In another implementation, the number of time units reserved in the first uplink channel is determined as the number of retransmissions. That is, the terminal may not consider the nominal number of retransmissions and the actual number of retransmissions, and directly determine the number of time units reserved in the first uplink channel as the number of retransmissions.

In the step 604, a target TRP among the at least two TRPs is determined based on the number of retransmissions.

In embodiments of the present disclosure, the method of determining the target TRP is similar to that in the above-mentioned embodiments, which will not be repeated here.

In the step 605, information of the time unit reserved in the first uplink channel is transmitted by the target TRP.

In the above embodiments, in a case where the first uplink channel is the PUSCH and the retransmission type is the first type, different methods can be used to determine the number of retransmissions, so that the target TRP can be determined among the at least two TRPs based on the number of retransmissions, and the purpose of improving the transmission reliability of the M-TRP system is also achieved.

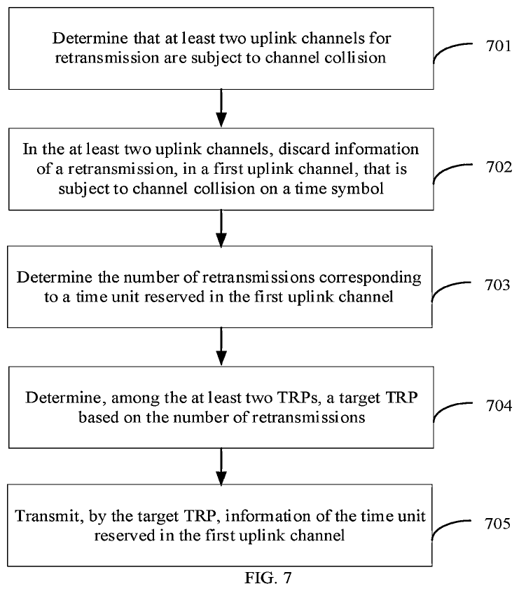

In some embodiments, referring to FIG. 7, FIG. 7 shows a flowchart of a retransmission method according to an embodiment, the method may be used in the terminal, and may include steps 701 to 705.

In the step 701, it is determined that at least two uplink channels for retransmission are subject to channel collision.

In embodiments of the present disclosure, the uplink channel used for retransmission may refer to a PUCCH retransmission channel or a PUSCH retransmission channel, and the at least two uplink channels may be transmitted by at least two Transmission Reception Points (TRPs), respectively. When the at least two uplink channels used for retransmission overlap in one or more time units, it is determined that the channel collision occurs in the at least two uplink channels for retransmission. The time unit may be a slot or a sub-slot.

In the step 702, information of the retransmission, in the first uplink channel, that is subject to channel collision on a time symbol is discarded in the at least two uplink channels.

In embodiments of the present disclosure, the at least two uplink channels may carry UCI with different priorities. The first uplink channel is a PUCCH, and the retransmission is performed by the first uplink channel based on the sub-slot. In the related arts, the information of the retransmission in an entire slot needs to be discarded, which causes the transmission delay of the low-priority UCI. In embodiments of the present disclosure, only the information of the retransmission in the time symbol (that is, the sub-slot) where the channel collision occurs may be discarded.

In the step 703, the number of retransmissions corresponding to a time unit reserved in the first uplink channel is determined.

In the step 704, a target TRP among the at least two TRPs is determined based on the number of retransmissions.

In embodiments of the present disclosure, the method of determining the target TRP is similar to that in the above-mentioned embodiments, which will not be repeated here.

In step 705, information of the time unit reserved in the first uplink channel is transmitted by the target TRP.

In the above embodiments, in a case where the first uplink channel is the Physical Uplink Control Channel (PUCCH) and the retransmission is performed by the first uplink channel based on the sub-slot, only the information of the retransmission in the first uplink channel that is subject to the channel collision on the time symbol may be discarded, thereby effectively reducing the transmission delay of the low-priority UCI.

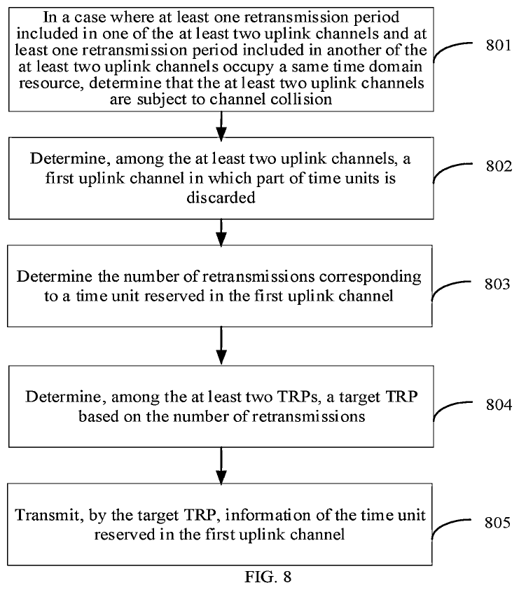

In some embodiments, referring to FIG. 8, FIG. 8 shows a flowchart of a retransmission method according to an embodiment, the method may be used in the terminal, and may include steps 801 to 805.

In the step 801, in a case where at least one retransmission period included in one of the at least two uplink channels and at least one retransmission period included in another of the at least two uplink channels occupy the same time domain resource, it is determined that the at least two uplink channels are subject to the channel collision.

In embodiments of the present disclosure, each retransmission period includes a time unit for retransmission and a time unit occupied by beam switching.

That is, the channel collision in the present disclosure can consider a beam switching interval, and each retransmission period is defined to include not only the time unit used for retransmission but also the time unit occupied by the beam switching. When the at least two uplink channels overlap in the time unit occupied by the beam switching interval of the at least one uplink channel, it is also determined that the channel collision occurs.

In the step 802, a first uplink channel in which part of time units is discarded is determined among the at least two uplink channels.

In embodiments of the present disclosure, the at least two uplink channels may carry UCI with different priorities.

In an implementation, the terminal may use, among the at least two channels, an uplink channel carrying UCI with the lowest priority as the first uplink channel.

In the step 803, the number of retransmissions corresponding to a time unit reserved in the first uplink channel is determined.

In the step 804, a target TRP among the at least two TRPs is determined based on the number of retransmissions.

In embodiments of the present disclosure, the method of determining the target TRP is similar to that in the above-mentioned embodiments, which will not be repeated here.

In the step 805, information of the time unit reserved in the first uplink channel is transmitted by the target TRP.

In the above embodiments, when it is determined whether the channel collision occurs, the beam switching interval may be considered, thereby improving the accuracy of determining the channel collision situation and achieving high availability.

In order to facilitate understanding of the retransmission method provided by the present disclosure, further examples are given as follows.

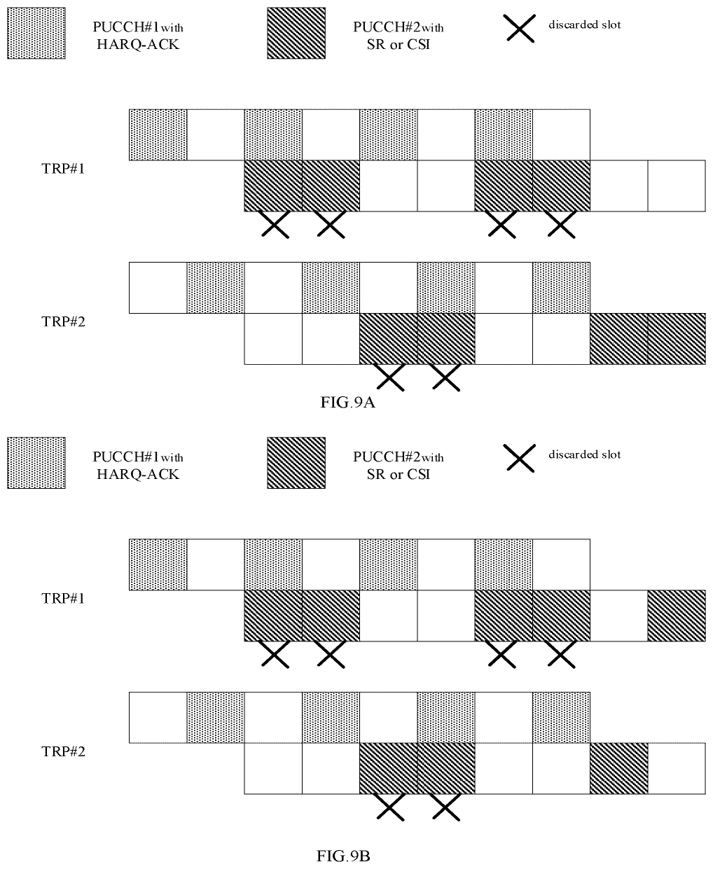

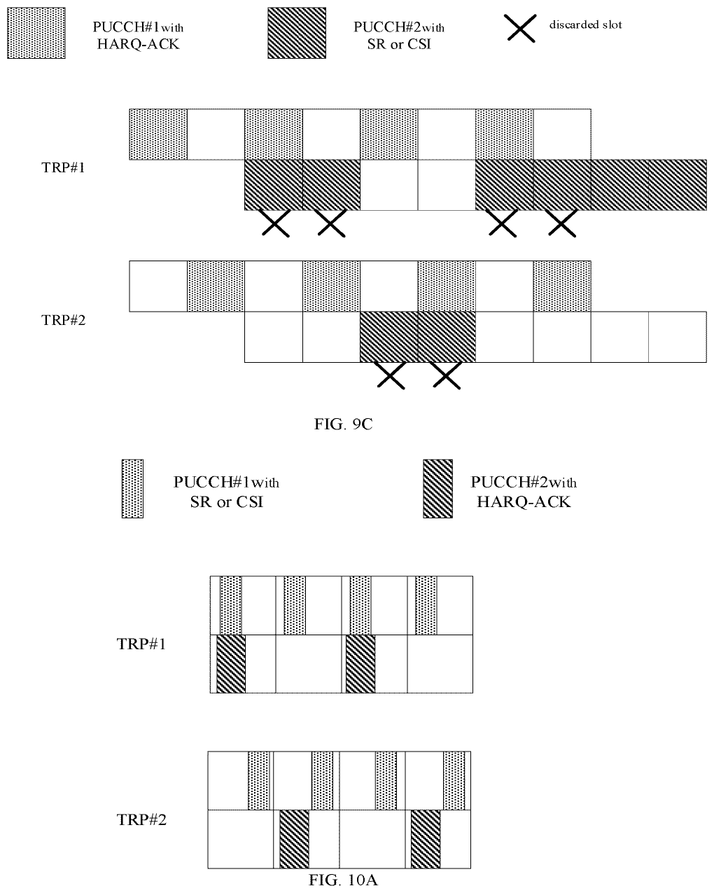

As shown in FIG. 9A, two uplink channels used for retransmission are respectively PUCCH #1 and PUCCH #2, which are transmitted through TRP #1 and TRP #2, respectively. The carried UCI is respectively HARQ-ACK, and SR or CSI. The channel collision occurs between PUCCH #1 and PUCCH #2, and the terminal determines that the first uplink channel in which some time units is discarded is PUCCH #2. According to the related arts, the information of the time unit reserved in PUCCH #2 will be transmitted by TRP #2.

However, according to the retransmission method provided by the present disclosure, the number of retransmissions corresponding to the time unit reserved in PUCCH #2 is 2. Correspondingly, both TRP #1 and TRP #2 can be used as target TRPs, and the terminal will use any TRP as the starting TRP, that is, TRP #1 or TRP #2 can be used as the starting TRP, or the terminal will use the TRP used to transmit the first uplink channel, that is, TRP #2, as the starting TRP. In FIG. 9B, the terminal uses TRP #2 as the starting TRP. Further, starting from TRP #2, the terminal cyclically maps the information of the time unit reserved in PUCCH #2 corresponding to each retransmission to different target TRPs, that is, mapping to TRP #2 and TRP #1, respectively. Further, starting from TRP #2, TRP #2 transmits the mapped information of the time unit, and TRP #1 transmits the mapped information of the time unit.

In embodiments of the present disclosure, the number of retransmissions corresponding to the time unit reserved in PUCCH #2 is 2. The second uplink channel with the best channel quality may also be determined among PUCCH #1 and PUCCH #2, which is assumed to be PUCCH #1. As shown in FIG. 9C, TRP1 used to transmit PUCCH #1 is used as the target TRP. Finally, the information of the time unit reserved in PUCCH #2 is transmitted through TRP #1.

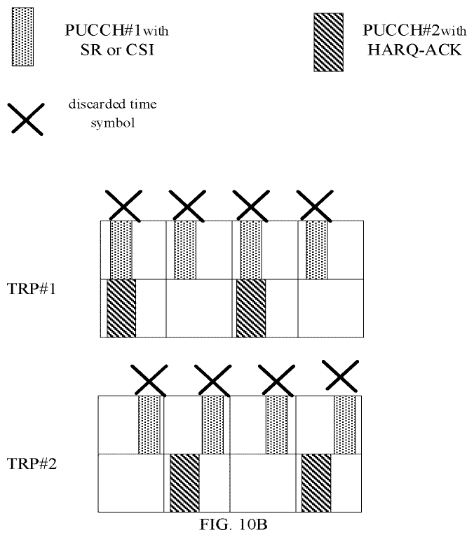

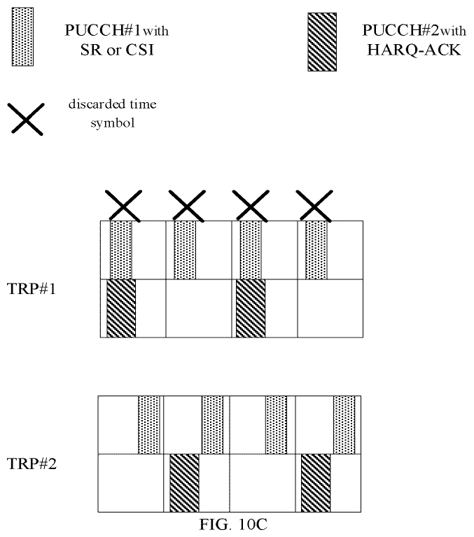

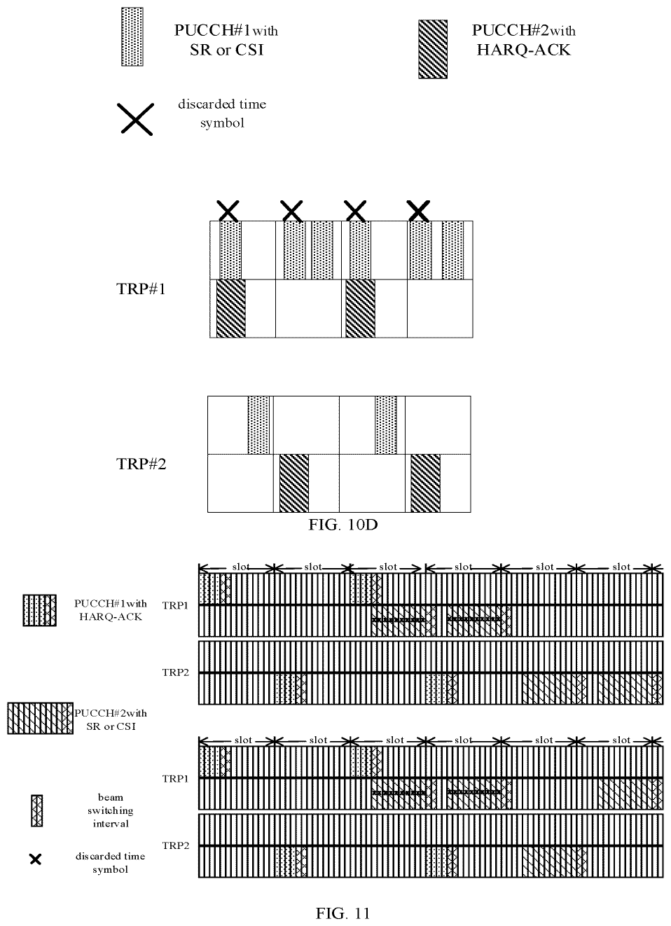

Referring to FIG. 10A again, the two uplink channels used for retransmission are respectively PUCCH #1 and PUCCH #2, which are transmitted by TRP #1 and TRP #2, respectively, and the carried UCI is SR or CSI, and HARQ-ACK, respectively. The retransmission is performed by PUCCH #1 and PUCCH #2 based on the sub-slot, and the channel collision occurs between PUCCH #1 and PUCCH #2. The terminal determines that the first uplink channel in which part of the time units is discarded is PUCCH #1. According to the related arts, in each slot of FIG. 10A, the information of the two retransmissions of PUCCH #1 will be discarded. As shown in FIG. 10B, the information of PUCCH #1 used to carry UCI as SR or CSI is discarded, which will inevitably cause the transmission delay of the low-priority UCI.

According to the retransmission method provided in the present disclosure, the information of the last retransmission of PUCCH #1 in a first slot is reserved, and the information of the four retransmissions finally reserved can all be transmitted through TRP #2, as shown in FIG. 10C.

Furthermore, the information of the time symbol reserved in PUCCH #1 that is transmitted by TRP #2 can be mapped to TRP #2 and TRP #1 in a cyclic mapping manner. The specific transmission manner is shown in FIG. 10D.

Referring to the upper figure in FIG. 11, when it is considered that the M-TRP transmission on the two beams needs the beam switching interval, it is assumed that the channel collision occurs between the retransmission of the PUCCH carrying HARQ-ACK and the retransmission of the PUCCH carrying SR or CSI, and the switching interval is 2 symbols. If PUCCH #1 and PUCCH #2 overlap in the time symbol for the beam switching, the information of the overlapped retransmission of the PUCCH #2 carrying SR/CSI is discarded.

In the related arts, the information of the time unit reserved in PUCCH #2 is all transmitted on TRP #2. In embodiments of the present disclosure, the cyclic mapping manner can be used, in order to transmit the information of the time unit reserved in PUCCH #2 by TRP #2 and TRP #1, respectively, as shown in the lower figure in FIG. 11.

In the above embodiments, the channel collision rules in Rel-16 is improved, and when they are applied in the Rel-17 M-TRP PUCCH transmission scenario, the S-TRP transmission is adjusted to the M-TRP transmission or the transmission on the TRP with the best channel quality, thereby improving the transmission reliability of the M-TRP system.

Corresponding to the application function implementation method embodiments as mentioned above, the present disclosure further provides application function implementation apparatus embodiments.

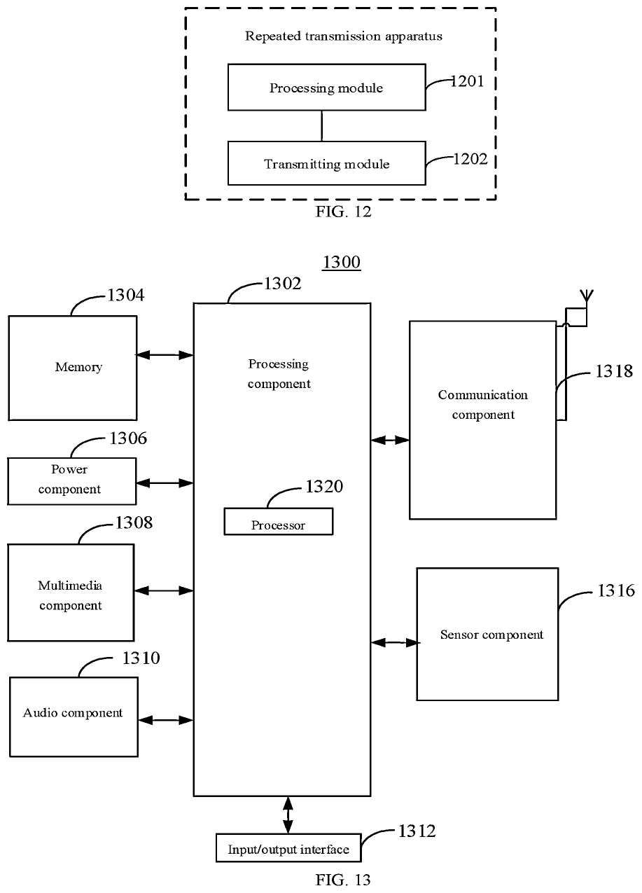

FIG. 12 shows a block diagram of a retransmission apparatus according to an embodiment of the present disclosure, and referring to FIG. 12, the apparatus includes:
a processing module 1201, configured to determine that at least two uplink channels for retransmission are subject to channel collision, wherein the at least two uplink channels are respectively transmitted by at least two Transmission Reception Points (TRPs);
the processing module 1201, further configured to determine, among the at least two uplink channels, a first uplink channel in which part of time units is discarded;
the processing module 1201, further configured to determine a number of retransmissions corresponding to a time unit reserved in the first uplink channel;
the processing module 1201, further configured to determine, among the at least two TRPs, a target TRP based on the number of retransmissions; and
a transmitting module 1202, configured to transmit, by the target TRP, information of the time unit reserved in the first uplink channel.

In some embodiments of the present disclosure, when the number of retransmissions is 1, a number of target TRPs is 1; and
the processing module is further configured to:
determine a second uplink channel with a best channel quality among the at least two uplink channels; and
determine, among the at least two TRPs, a TRP for transmission of the second uplink channel as the target TRP.

In some embodiments of the present disclosure, when the number of retransmissions is greater than 1, a number of target TRPs is 1; and
the processing module is further configured to:
determine a second uplink channel with a best channel quality among the at least two uplink channels; and
determine, among the at least two TRPs, a TRP for transmission of the second uplink channel as the target TRP.

In some embodiments of the present disclosure, when the number of retransmissions is greater than 1, a number of target TRPs is the same as a number of channels of the at least two uplink channels;
the processing module is further configured to:
determine the at least two TRPs as target TRPs.

In some embodiments of the present disclosure, the processing module is further configured to:
determine a starting TRP, wherein the starting TRP is a TRP among the target TRPs that starts transmitting the information of the time unit reserved in the first uplink channel the earliest; and
based on the number of retransmissions, cyclically map, starting from the starting TRP, the information of the time unit, reserved in the first uplink channel, corresponding to each retransmission to different target TRPs, respectively;
the transmitting module is further configured to:
starting from the starting TRP, transmit, by the different target TRPs, the mapped information of the time unit, respectively.

In some embodiments of the present disclosure, the processing module is further configured to:
determine any one of the at least two TRPs as the starting TRP; or
determine a TRP for transmission of the first uplink channel as the starting TRP.

In some embodiments of the present disclosure, the first uplink channel is a Physical Uplink Shared Channel (PUSCH), and a retransmission type is a first type, and the processing module is further configured to:
determine a nominal number of retransmissions corresponding to the time unit reserved in the first uplink channel; or
determine an actual number of retransmissions corresponding to the time unit reserved in the first uplink channel; or
determine a number of time units reserved in the first uplink channel as the number of retransmissions.

In some embodiments of the present disclosure, the first uplink channel is a Physical Uplink Control Channel(PUCCH), and retransmission is performed by the first uplink channel based on a sub-slot, and the processing module is further configured to:
discard information of a retransmission, in the first uplink channel, that is subject to channel collision on a time symbol.

In some embodiments of the present disclosure, the processing module is further configured to:
in a case where at least one retransmission period included in one of the at least two uplink channels and at least one retransmission period included in another of the at least two uplink channels occupy a same time domain resource, determine that the at least two uplink channels are subject to the channel collision, wherein each retransmission period includes a time unit for retransmission and a time unit occupied by beam switching.

Regarding the apparatus embodiments, since they basically correspond to the method embodiments, the relevant parts can be referred to the description of the method embodiments. The apparatus embodiments described above are only illustrative. The units described as separated parts may or may not be physically separated, and the parts displayed as units may or may not be physical units, that is, the units may be located in one place, or may be distributed over multiple network units. Some or all of the modules may be selected according to actual needs to achieve the objectives of the solutions in the present disclosure. Those of ordinary skill in the art can understand and implement the present disclosure without paying creative labor.

Correspondingly, the present disclosure further provides a computer-readable storage medium having a computer program stored thereon, and the computer program is configured to execute any retransmission method as described above.

Correspondingly, the present disclosure further provides a communication device, including:
a processor; and
a memory configured to store executable instructions of the processor;
the processor is configured to perform any retransmission method as described above.

FIG. 13 shows a block diagram of a communication device 1300 according to an embodiment of the present disclosure. For example, the communication device 1300 may be a mobile phone, a tablet computer, an e-book reader, a multimedia playback device, a wearable device, a vehicle-mounted terminal, an iPad, a smart TV, and other terminals.

Referring to FIG. 13, the communication device 1300 may include one or more of the following components: a processing component 1302, a memory 1304, a power component 1306, a multimedia component 1308, an audio component 1310, an input/output (I/O) interface 1312, a sensor component 1316, and a communication component 1318.

The processing component 1302 typically controls overall operations of the communication device 1300, such as the operations associated with display, telephone calls, data communications, camera operations, and recording operations. The processing component 1302 may include one or more processors 1320 to execute instructions to perform all or part of the steps in the above described methods. Moreover, the processing component 1302 may include at least one module which facilitate the interaction between the processing component 1302 and other components. For instance, the processing component 1302 may include a multimedia module to facilitate the interaction between the multimedia component 1308 and the processing component 1302. As another example, the processing component 1302 may read executable instructions from the memory to implement steps of the retransmission method provided by the above embodiments.

The memory 1304 is configured to store various types of data to support the operation of the communication device 1300. Examples of such data include instructions for any applications or methods operated on the communication device 1300, contact data, phonebook data, messages, pictures, video, etc. The memory 1304 may be implemented using any type of volatile or non-volatile memory apparatuses, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1306 provides power to various components of the communication device 1300. The power component 1306 may include a power management system, one or more power sources, and any other components associated with the generation, management, and distribution of power in the communication device 1300.

The multimedia component 1308 includes a display screen providing an output interface between the communication device 1300 and the user. In some embodiments, the multimedia component 1308 includes a front camera and/or a rear camera. The front camera and the rear camera may receive an external multimedia datum while the communication device 1300 is in an operation mode, such as a photographing mode or a video mode. Each of the front camera and the rear camera may be a fixed optical lens system or have focus and optical zoom capability.

The audio component 1310 is configured to output and/or input audio signals. For example, the audio component 1310 includes a microphone (MIC) configured to receive an external audio signal when the communication device 1300 is in an operation mode, such as a call mode, a recording mode, and a voice recognition mode. The received audio signal may be further stored in the memory 1304 or transmitted via the communication component 1318. In some embodiments, the audio component 1310 further includes a speaker to output audio signals.

The I/O interface 1312 provides an interface between the processing component 1302 and peripheral interface modules, such as a keyboard, a click wheel, buttons, and the like. The buttons may include, but are not limited to, a home button, a volume button, a starting button, and a locking button.

The sensor component 1316 includes one or more sensors to provide state assessments of various aspects of the communication device 1300. For instance, the sensor component 1316 may detect an open/closed state of the communication device 1300, relative positioning of components, e.g., the display and the keypad of the communication device 1300, a change in position of the communication device 1300 or a component of the communication device 1300, a presence or absence of user contact with the communication device 1300, an orientation or an acceleration/deceleration of the communication device 1300, and a change in temperature of the communication device 1300. The sensor component 1316 may include a proximity sensor configured to detect the presence of nearby objects without any physical contact. The sensor component 1316 may further include a light sensor, such as a CMOS or CCD image sensor, for use in imaging applications. In some embodiments, the sensor component 1316 may further include an accelerometer sensor, a gyroscope sensor, a magnetic sensor, a pressure sensor, or a temperature sensor.

The communication component 1318 is configured to facilitate communication, wired or wirelessly, between the communication device 1300 and other devices. The communication device 1300 may access a wireless network based on a communication standard, such as WiFi, 2G, 3G, 4G or 5G, or a combination thereof. In an embodiment, the communication component 1318 receives a broadcast signal or broadcast associated information from an external broadcast management system via a broadcast channel. In an embodiment, the communication component 1318 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In an embodiment of the present disclosure, the communication device 1300 may be implemented with one or more application specific integrated circuits (ASICs), digital signals (DSPs), digital signal processing devices (DSPDs), programmable logic devices (PLDs), field programmable gate arrays (FPGA), controllers, micro-controllers, microprocessors, or other electronic components, for performing the above described retransmission methods.

In an embodiment of the present disclosure, there is further provided a non-transitory machine readable storage medium including instructions, such as the memory 1304 including instructions executable by the processor 1320 in the communication device 1300, for performing the above-described retransmission methods. For example, the non-transitory computer-readable storage medium may be a ROM, a RAM, a CD-ROM, a magnetic tape, a floppy disc, an optical data storage device, and the like

Embodiments of the present disclosure provide a retransmission method and apparatus, and a storage medium.

According to a first aspect of embodiments of the present disclosure, there is provided a retransmission method, which is applied to a terminal, and the method includes:
determining that at least two uplink channels for retransmission are subject to channel collision, wherein the at least two uplink channels are respectively transmitted by at least two Transmission Reception Points (TRPs);
determining, among the at least two uplink channels, a first uplink channel in which part of time units is discarded;
determining a number of retransmissions corresponding to a time unit reserved in the first uplink channel;
determining, among the at least two TRPs, a target TRP based on the number of retransmissions; and
transmitting, by the target TRP, information of the time unit reserved in the first uplink channel.

When the number of retransmissions is 1, a number of target TRPs is 1; and
the determining, among the at least two TRPs, the target TRP based on the number of retransmissions includes:
determining a second uplink channel with a best channel quality among the at least two uplink channels; and
determining, among the at least two TRPs, a TRP for transmission of the second uplink channel as the target TRP.

In some embodiments of the present disclosure, when the number of retransmissions is greater than 1, a number of target TRPs is 1; and
the determining, among the at least two TRPs, the target TRP based on the number of retransmissions includes:
determining a second uplink channel with a best channel quality among the at least two uplink channels; and
determining, among the at least two TRPs, a TRP for transmission of the second uplink channel as the target TRP.

In some embodiments of the present disclosure, when the number of retransmissions is greater than 1, a number of target TRPs is the same as a number of channels of the at least two uplink channels;
the determining, among the at least two TRPs, the target TRP based on the number of retransmissions includes:
determining the at least two TRPs as target TRPs.

In some embodiments of the present disclosure, the method further includes:
determining a starting TRP, wherein the starting TRP is a TRP among the target TRPs that starts transmitting the information of the time unit reserved in the first uplink channel the earliest; and
based on the number of retransmissions, cyclically mapping, starting from the starting TRP, the information of the time unit, reserved in the first uplink channel, corresponding to each retransmission to different target TRPs, respectively;
the transmitting, by the target TRP, the information of the time unit reserved in the first uplink channel includes:
starting from the starting TRP, transmitting, by the different target TRPs, the mapped information of the time unit, respectively.

In some embodiments of the present disclosure, the determining the starting TRP includes:
determining any one of the at least two TRPs as the starting TRP; or
determining a TRP for transmission of the first uplink channel as the starting TRP.

In some embodiments of the present disclosure, the first uplink channel is a Physical Uplink Shared Channel (PUSCH), and a retransmission type is a first type, and the determining the number of retransmissions corresponding to the time unit reserved in the first uplink channel includes:
determining a nominal number of retransmissions corresponding to the time unit reserved in the first uplink channel; or
determining an actual number of retransmissions corresponding to the time unit reserved in the first uplink channel; or
determining a number of time units reserved in the first uplink channel as the number of retransmissions.

In some embodiments of the present disclosure, the first uplink channel is a Physical Uplink Control Channel(PUCCH), and retransmission is performed by the first uplink channel based on a sub-slot, and the method further includes:
discarding information of a retransmission, in the first uplink channel, that is subject to channel collision on a time symbol.

In some embodiments of the present disclosure, the determining that the at least two uplink channels for retransmission are subject to the channel collision includes:
in a case where at least one retransmission period included in one of the at least two uplink channels and at least one retransmission period included in another of the at least two uplink channels occupy a same time domain resource, determining that the at least two uplink channels are subject to the channel collision, wherein each retransmission period includes a time unit for retransmission and a time unit occupied by beam switching.

According to a second aspect of embodiments of the present disclosure, there is provided a retransmission apparatus, including:
a processing module, configured to determine that at least two uplink channels for retransmission are subject to channel collision, wherein the at least two uplink channels are respectively transmitted by at least two Transmission Reception Points (TRPs);
the processing module, further configured to determine, among the at least two uplink channels, a first uplink channel in which part of time units is discarded;
the processing module, further configured to determine a number of retransmissions corresponding to a time unit reserved in the first uplink channel;
the processing module, further configured to determine, among the at least two TRPs, a target TRP based on the number of retransmissions; and
a transmitting module, configured to transmit, by the target TRP, information of the time unit reserved in the first uplink channel.

In some embodiments of the present disclosure, when the number of retransmissions is 1, a number of target TRPs is 1; and
the processing module is further configured to:
determine a second uplink channel with a best channel quality among the at least two uplink channels; and
determine, among the at least two TRPs, a TRP for transmission of the second uplink channel as the target TRP.

In some embodiments of the present disclosure, when the number of retransmissions is greater than 1, a number of target TRPs is 1; and
the processing module is further configured to:
determine a second uplink channel with a best channel quality among the at least two uplink channels; and
determine, among the at least two TRPs, a TRP for transmission of the second uplink channel as the target TRP.

In some embodiments of the present disclosure, when the number of retransmissions is greater than 1, a number of target TRPs is the same as a number of channels of the at least two uplink channels;
the processing module is further configured to:
determine the at least two TRPs as target TRPs.

In some embodiments of the present disclosure, the processing module is further configured to:
determine a starting TRP, wherein the starting TRP is a TRP among the target TRPs that starts transmitting the information of the time unit reserved in the first uplink channel the earliest; and
based on the number of retransmissions, cyclically map, starting from the starting TRP, the information of the time unit, reserved in the first uplink channel, corresponding to each retransmission to different target TRPs, respectively;
the transmitting module is further configured to:
starting from the starting TRP, transmit, by the different target TRPs, the mapped information of the time unit, respectively.

In some embodiments of the present disclosure, the processing module is further configured to:
determine any one of the at least two TRPs as the starting TRP; or
determine a TRP for transmission of the first uplink channel as the starting TRP.

In some embodiments of the present disclosure, the first uplink channel is a Physical Uplink Shared Channel (PUSCH), and a retransmission type is a first type, and the processing module is further configured to:
determine a nominal number of retransmissions corresponding to the time unit reserved in the first uplink channel; or
determine an actual number of retransmissions corresponding to the time unit reserved in the first uplink channel; or
determine a number of time units reserved in the first uplink channel as the number of retransmissions.

In some embodiments of the present disclosure, the first uplink channel is a Physical Uplink Control Channel(PUCCH), and retransmission is performed by the first uplink channel based on a sub-slot, and the processing module is further configured to:
discard information of a retransmission, in the first uplink channel, that is subject to channel collision on a time symbol.

In some embodiments of the present disclosure, the processing module is further configured to:
in a case where at least one retransmission period included in one of the at least two uplink channels and at least one retransmission period included in another of the at least two uplink channels occupy a same time domain resource, determine that the at least two uplink channels are subject to the channel collision, wherein each retransmission period includes a time unit for retransmission and a time unit occupied by beam switching.

According to a third aspect of embodiments of the present disclosure, there is provided a computer-readable storage medium having a computer program stored thereon, wherein the computer program is configured to implement any retransmission method as described above.

According to a fourth aspect of embodiments of the present disclosure, there is provided a communication device, including:
a processor; and
a memory configured to store executable instructions of the processor;
wherein the processor is configured to execute the executable instructions to implement any retransmission method as described above.

The technical solutions provided by embodiments of the present disclosure may include the following beneficial effects:

In the present disclosure, in the case where the channel collision occurs in the at least two uplink channels for retransmission, the terminal may determine the target TRP among the at least two TRPs, and use the target TRP to transmit the information of the time unit reserved in the first uplink channel in which part of time units is discarded, thereby improving the transmission reliability of the M-TRP system.

Other embodiments of the present disclosure will be apparent to those skilled in the art from consideration of the specification and practice of the present disclosure disclosed here. The present disclosure is intended to cover any variations, uses, or adaptations of the present disclosure following the general principles thereof and including the common general knowledge or habitual technical means in the technical field not disclosed in the present disclosure. The specification and embodiments are considered as exemplary only, and a true scope and spirit of the present disclosure is indicated by the appending claims.

It will be appreciated that the present disclosure is not limited to the exact construction that has been described above and illustrated in the accompanying drawings, and that various modifications and changes may be made without departing from the scope thereof. It is intended that the scope of the present disclosure only be limited by the appended claims.

1. A retransmission method, performed by a terminal, comprising:
determining that at least two uplink channels for retransmission are subject to channel collision, wherein the at least two uplink channels are respectively transmitted by at least two Transmission Reception Points (TRPs);
determining, among the at least two uplink channels, a first uplink channel in which a part of time units is discarded;
determining a number of retransmissions corresponding to a time unit reserved in the first uplink channel;
determining, among the at least two TRPs, a target TRP based on the number of retransmissions; and
transmitting, by the target TRP, information of the time unit reserved in the first uplink channel.

2. The method according to claim 1, wherein the number of retransmissions is 1, and a number of target TRPs is 1, and
wherein determining, among the at least two TRPs, the target TRP based on the number of retransmissions comprises:
determining a second uplink channel with a best channel quality among the at least two uplink channels; and
determining, among the at least two TRPs, a TRP for transmission of the second uplink channel as the target TRP.

3. The method according to claim 1, wherein the number of retransmissions is greater than 1, and a number of target TRPs is 1, and
wherein determining, among the at least two TRPs, the target TRP based on the number of retransmissions comprises:
determining a second uplink channel with a best channel quality among the at least two uplink channels; and
determining, among the at least two TRPs, a TRP for transmission of the second uplink channel as the target TRP.

4. The method according to claim 1, wherein the number of retransmissions is greater than 1, and a number of target TRPs is the same as a number of channels of the at least two uplink channels, and
wherein determining, among the at least two TRPs, the target TRP based on the number of retransmissions comprises:
determining the at least two TRPs as target TRPs.

5. The method according to claim 4, wherein the method further comprises:
determining a starting TRP, wherein the starting TRP is a TRP among the target TRPs that starts transmitting the information of the time unit reserved in the first uplink channel the earliest; and
based on the number of retransmissions, cyclically mapping, starting from the starting TRP, the information of the time unit, reserved in the first uplink channel, corresponding to each retransmission to different target TRPs, respectively,
wherein transmitting, by the target TRP, the information of the time unit reserved in the first uplink channel comprises:
starting from the starting TRP, transmitting, by the different target TRPs, the mapped information of the time unit, respectively.

6. The method according to claim 5, wherein determining the starting TRP comprises:
determining any one of the at least two TRPs as the starting TRP; or
determining a TRP for transmission of the first uplink channel as the starting TRP.

7. The method according to claim 1, wherein the first uplink channel is a Physical Uplink Shared Channel (PUSCH), and a retransmission type is a first type, and
wherein determining the number of retransmissions corresponding to the time unit reserved in the first uplink channel comprises one of:
determining a nominal number of retransmissions corresponding to the time unit reserved in the first uplink channel;
determining an actual number of retransmissions corresponding to the time unit reserved in the first uplink channel; or
determining a number of time units reserved in the first uplink channel as the number of retransmissions.

8. The method according to claim 1, wherein the first uplink channel is a Physical Uplink Control Channel (PUCCH), and retransmission is performed by the first uplink channel based on a sub-slot, and the method further comprises:
discarding information of a retransmission, in the first uplink channel, that is subject to channel collision on a time symbol.

9. The method according to claim 1, wherein determining that the at least two uplink channels for retransmission are subject to the channel collision comprises:
determining that the at least two uplink channels are subject to the channel collision, wherein at least one retransmission period comprised in one of the at least two uplink channels and at least one retransmission period comprised in another of the at least two uplink channels occupy a same time domain resource, and each retransmission period comprises a time unit for retransmission and a time unit occupied by beam switching.

10-18. (canceled)

19. A non-transitory computer-readable storage medium having a computer program stored thereon, wherein the computer program is configured to implement a method comprising:
determining that at least two uplink channels for retransmission are subject to channel collision, wherein the at least two uplink channels are respectively transmitted by at least two Transmission Reception Points (TRPs);
determining, among the at least two uplink channels, a first uplink channel in which a part of time units is discarded;
determining a number of retransmissions corresponding to a time unit reserved in the first uplink channel;
determining, among the at least two TRPs, a target TRP based on the number of retransmissions; and
transmitting, by the target TRP, information of the time unit reserved in the first uplink channel.

20. A communication device, comprising:
a processor; and
a memory configured to store instructions executable by the processor,
wherein the processor is configured to:
determine that at least two uplink channels for retransmission are subject to channel collision, wherein the at least two uplink channels are respectively transmitted by at least two Transmission Reception Points (TRPs);
determine, among the at least two uplink channels, a first uplink channel in which a part of time units is discarded;
determine a number of retransmissions corresponding to a time unit reserved in the first uplink channel;
determine, among the at least two TRPs, a target TRP based on the number of retransmissions; and
transmit, by the target TRP, information of the time unit reserved in the first uplink channel.

21. The communication device according to claim 20, wherein the number of retransmissions is 1, and a number of target TRPs is 1, and
wherein the processor is further configured to:
determine a second uplink channel with a best channel quality among the at least two uplink channels; and
determine, among the at least two TRPs, a TRP for transmission of the second uplink channel as the target TRP.

22. The communication device according to claim 20, wherein the number of retransmissions is greater than 1, and a number of target TRPs is 1, and
wherein the processor is further configured to:
determine a second uplink channel with a best channel quality among the at least two uplink channels; and
determine, among the at least two TRPs, a TRP for transmission of the second uplink channel as the target TRP.

23. The communication device according to claim 20, wherein the number of retransmissions is greater than 1, and a number of target TRPs is the same as a number of channels of the at least two uplink channels, and
wherein the processor is further configured to:
determine the at least two TRPs as target TRPs.

24. The communication device according to claim 23, wherein the processor is further configured to:
determine a starting TRP, wherein the starting TRP is a TRP among the target TRPs that starts transmitting the information of the time unit reserved in the first uplink channel the earliest;
based on the number of retransmissions, cyclically map, starting from the starting TRP, the information of the time unit, reserved in the first uplink channel, corresponding to each retransmission to different target TRPs, respectively; and
starting from the starting TRP, transmit, by the different target TRPs, the mapped information of the time unit, respectively.

25. The communication device according to claim 24, wherein the processor is further configured to:
determine any one of the at least two TRPs as the starting TRP; or
determine a TRP for transmission of the first uplink channel as the starting TRP.

26. The communication device according to claim 20, wherein the first uplink channel is a Physical Uplink Shared Channel (PUSCH), and a retransmission type is a first type, and the processor is further configured to:
determine a nominal number of retransmissions corresponding to the time unit reserved in the first uplink channel;
determine an actual number of retransmissions corresponding to the time unit reserved in the first uplink channel; or
determine a number of time units reserved in the first uplink channel as the number of retransmissions.

27. The communication device according to claim 20, wherein the first uplink channel is a Physical Uplink Control Channel (PUCCH), and retransmission is performed by the first uplink channel based on a sub-slot, and the processor is further configured to:
discard information of a retransmission, in the first uplink channel, that is subject to channel collision on a time symbol.

28. The communication device according to claim 20, wherein the processor is further configured to:
determine that the at least two uplink channels are subject to the channel collision, wherein at least one retransmission period comprised in one of the at least two uplink channels and at least one retransmission period comprised in another of the at least two uplink channels occupy a same time domain resource, and each retransmission period comprises a time unit for retransmission and a time unit occupied by beam switching.
